(19) United States
(12) Patent Application Publication
(10) Pub. No.: US 2012/0271693 A1
(43) Pub. Date: Oct. 25, 2012

(54) System and Method for Marketing and Promoting Products and Services Over the Internet

(76) Inventor: Robert Toczycki, Arlington Heights, IL (US)

(21) Appl. No.: 13/093,055

(22) Filed: Apr. 25, 2011

(51) Int. Cl. G06Q 30/00

(52) U.S. Cl. 705/14.23

(57) ABSTRACT

The present invention provides a marketing system and method that incentivizes marketing of goods and services to buyers through networks, such as social networks. In the present invention, agents are given incentives to locate merchants and to market products and services from those merchants over the Internet, while an operator manages the transactions.

### FIELD OF THE INVENTION

This invention relates to the business of offering, buying, and selling of products and services over electronic systems such as the Internet and other computer networks, commonly known as electronic commerce or e-commerce, and more particularly to a system and method for marketing and promoting products and services through the Internet.

### BACKGROUND OF THE INVENTION

The Internet hosts many various operator websites that help manage, promote, market, and sell products and services for merchants looking to expand and increase their business. Some of these various operator websites employ what are called “group buying” techniques, wherein products or services are limited in availability and may only be valid if a large enough group of individuals purchase the products or services. These operator website employ various other techniques to help attract prospective buyers to purchase these products and services. These techniques include: limiting the quantity of the products and services, providing deep discounts on the products and services, and limiting the time to buy the products and services at the discounted price.

These operator websites may also provide incentives to help attract prospective buyers to purchase products and services on their website, such as providing a one-time referral fee for each friend that signs up and buys a product or service, or they may provide a larger discount if more buyers purchase the product or service.

The operator websites described above typically make their money by taking a percentage or commission from each sale. So it is therefore desirable for an operator to have merchants that are willing to offer up their products and services for sale on their website. It is also desirable for the operator to have the merchants discount their products and services as much as possible so as to increase the chances of selling more products and services. It is also further desirable for the merchant to provide a large enough commission on the sales so as to allow the operator to profit from the sales of products and services.

Finding and convincing merchants to offer their products and services for sale on an operator's website can be burdensome as it takes time to find and convince a merchant to provide a deep enough discount that is not only attractive to prospective buyers, but also provides a large enough commission to the operator. Often times, merchants may take a loss on the initial sale of their products or services so as to get their business going and to help establish a customer base that will come back to the merchant to purchase more products and/or services.

It is therefore desirable to have a system and method that helps an operator find and sign up more merchants willing to sell their products and/or services on the operator's website. It is also desirable to have a system and method that helps attract more buyers to the operator's website in order to purchase products and services featured on the operator's website. It is further desirable to have a system and method that helps a merchant to provide less of a discount on its products or services while increasing sales.

### SUMMARY OF THE INVENTION

The present invention provides a marketing system and method that incentivizes marketing of goods and services to buyers through networks, such as social networks. In the present invention, agents are given incentives to locate sellers and market products and services from those sellers over the Internet, while an operator manages the transactions.

### BRIEF DESCRIPTION OF THE DRAWINGS

The features and advantages of the present invention are illustrated by way of example and are not intended to be limited by the figures of the accompanying drawings, in which like references indicate similar elements and in which:

FIG. 1 is an overall block diagram of a computer network according to one embodiment of the present invention;

FIG. 2 is a block diagram of one aspect of a computer network in accordance with the present invention;

FIG. 3 is a block diagram illustrating one embodiment in accordance with the present invention;

FIG. 4 is a block diagram illustrating how a network can be used in accordance with the present invention;

FIG. 5A is a block diagram further illustrating the use of a link in a network in accordance with the present invention;

FIG. 5B is a block diagram illustrating another embodiment in accordance with the present invention;

FIG. 5C is a block diagram illustrating yet another embodiment in accordance with the present invention;

FIG. 6 is a flow chart of a method of signing up an agent in accordance with one embodiment of the present invention;

FIG. 7 is a flow chart of a method of signing up a merchant in accordance with the present invention;

FIG. 8 shows a screen shot for one embodiment of an agent application in accordance with the present invention;

FIG. 9 shows a screen shot for a merchant application in accordance with one embodiment of the present invention;

FIG. 10 shows a screen shot of the operator's website in accordance with one embodiment of the present invention;

FIG. 11 shows a screen shot of the operator's website in accordance with another embodiment of the present invention;

FIG. 12 shows a screen shot of a certificate issued by the operator in accordance with one embodiment of the present invention;

FIG. 13 is a flow chart illustrating one embodiment of how an operator handles a merchant's offer in accordance with the present invention;

FIG. 14 shows a screen shot of an agent offer selection page in accordance with one embodiment of the present invention;

FIG. 15 shows a screen shot of an originating agent's social network page in accordance with one embodiment of the present invention;

FIG. 16 is a flow chart illustrating another embodiment of how an operator handles a merchant's offer in accordance with the present invention;

FIG. 17 is a block diagram illustrating one embodiment of how e-commerce sales are distributed in accordance with the present invention;

FIG. 18 shows a screen shot of a referral agent offer selection page in accordance with another embodiment of the present invention;

FIG. 19 shows a screen shot of a referring agent's social network page in accordance with another embodiment of the present invention;

FIG. 20 is a flow chart illustrating yet another embodiment of how an operator handles a merchant's offer in accordance with the present invention;

FIG. 21 is a block diagram illustrating another embodiment of how e-commerce sales are distributed in accordance with the present invention;

FIG. 22 is a block diagram illustrating yet another embodiment of how e-commerce sales are distributed in accordance with the present invention;

FIG. 23 is a block diagram illustrating another aspect of how e-commerce sales are distributed in accordance with the present invention;

FIG. 24 is an overall block diagram of a computer network according to another embodiment of the present invention;

FIG. 25 is an overall block diagram of a computer network according to yet another embodiment of the present invention; and

FIG. 26 is an overall block diagram of a computer network according to still another embodiment of the present invention.

### DETAILED DESCRIPTION OF THE INVENTION

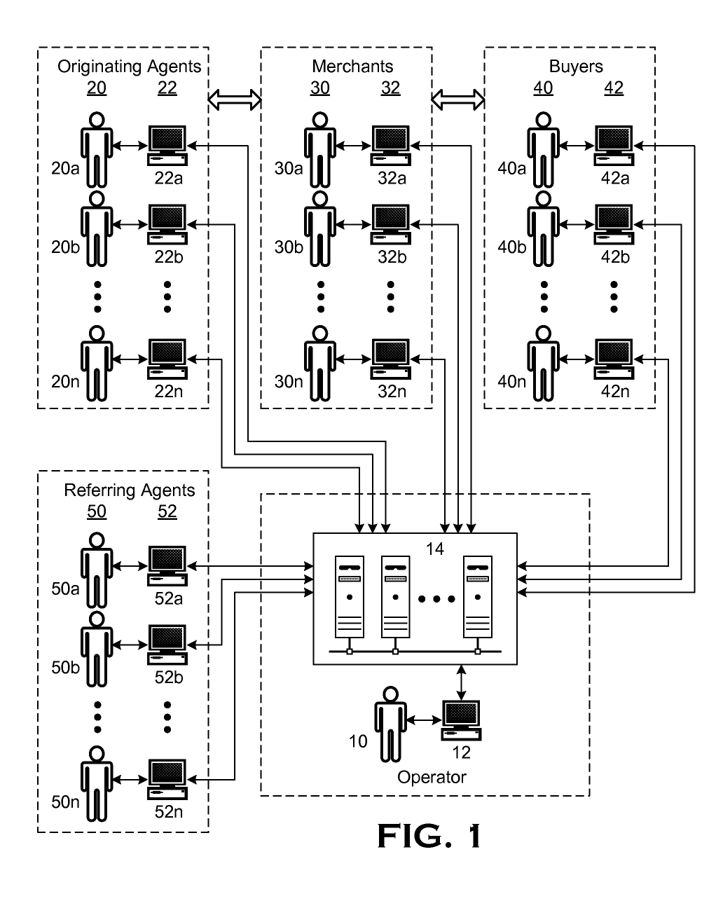

FIG. 1 shows an overall block diagram of a first preferred embodiment of the invention. In general, an operator 10 via a terminal 12 helps connect offers from merchants 30 with buyers 40, wherein the merchants 30 were originally signed-up to work with the operator 10 by an originating agent 20. Additionally, the buyers 40 may have been referred to offers from the merchant 30 by the originating agents 20 or the referring agents 50. The originating agents are designated 20a to 20n and are collectively referred to as originating agents 20. The merchants or sellers 30 are designated as 30a to 30n and are collectively referred to as merchants 30. The buyers 40 are designated as 40a to 40n and are collectively referred to as buyers 40. The referring agents 50 are designated as 50a to 50n and are collectively referred to as referring agents 50. There can be many originating agents 20, merchants 30, buyers 40 and referring agents 50, but there only needs to be one originating agent 20, one merchant 30 and one buyer 40.

Originating agents 20 communicate with the operator 10 through its servers 14 via client terminals 22 (individually designated 22a to 22n). The merchants 30 communicate with the operator 10 through its servers 14 via client terminals 32 (individually designated 32a to 32n). The buyers 40 communicate with the operator 10 through its servers 14 via client terminals 42 (individually designated 42a to 42n). The referring agents 50 communicate with the operator 10 through its servers 14 via client terminals 52 (individually designated 52a to 52n). The operator 10 communicates with its servers 14 via a client terminal 12. All of the client terminals can be of a number of different types that can connect to a computer network or the Internet, such as desktop computers, laptop computers, tablet computers, cell phones, interactive tv's, PDA's or any other interactive devices that can connect to the Internet.

As is conventional, client terminals 22, 32, 42, and 52 typically communicate through an ISP (Internet Service Provider) that provides access to the Internet. The operator's terminal 12 and servers 14 are also connected to the Internet via an ISP. Therefore the lines in FIG. 1, as well as the remaining figures, represent a logical flow of information and are not specific physical connections.

The operator's servers 14 are typical network servers that run software that hosts merchant offers and make it available for viewing; keeps track of the merchants 30; stores information about the originating agents 20; keeps track of the relationships between the originating agents 20, the merchants 30 and the buyers 40; keeps information on the buyers 40; keeps information on and help transact the sales of merchant offers made to buyers 40; keeps track of sales redeemed by buyers 40; stores information on referring agents 50; keeps track of the relationships between the referring agents 50, the merchants 30 and the buyers 40; and keeps track of and handles how sales are to be distributed between the originating agents 20, the merchants 30, the buyers, the referring agents 50 and the operator 10.

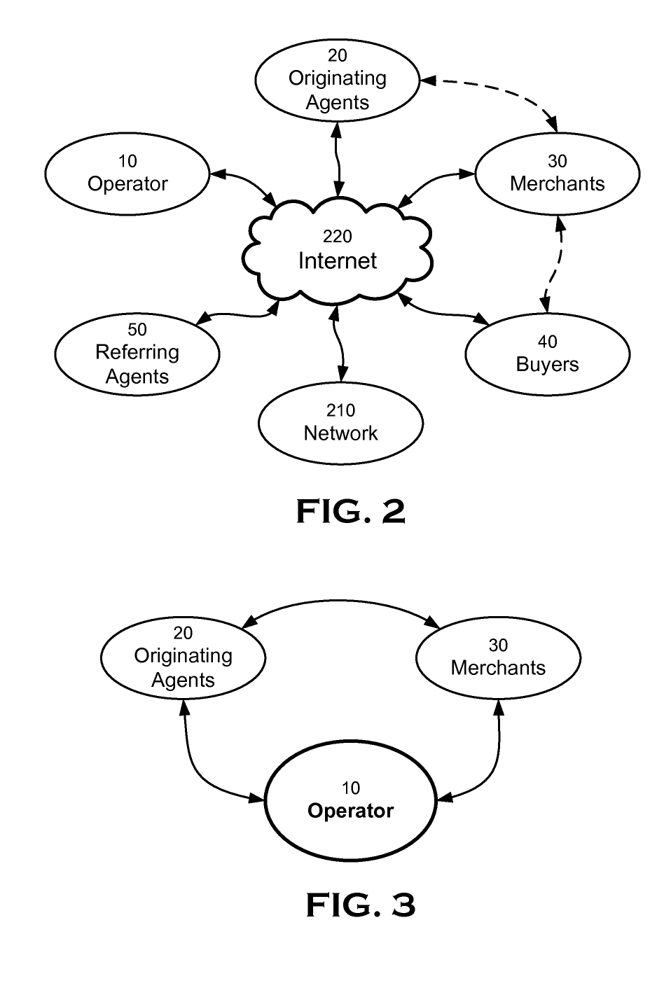

FIG. 2 illustrates a block diagram showing how the operator 10, originating agents 20, merchants 30, buyers 40, referring agents 50, and a network 210 are connected to the Internet 220. The network 210 is a computer network of individuals that are electronically and communicatively connected with other individuals. Examples of such networks are social and professional networks such as “Facebook”, “MySpace”, and “LinkedIn”, or they can be any type of web logs or blogs that individuals can read or participate in. The diagram also illustrates how the originating agents 20 can also be directly connected with the merchants 30, and how the buyers 40 can directly connect with the merchants 30. An originating agent 20 may initially contact a merchant 30 online through the Internet 220, or the originating agent 20 may also contact the merchant 30 directly in person or over a telephone. The buyer 40 may redeem the product or service purchased from the operator 10 online through the Internet, or the buyer 40 may redeem the product or service directly from the merchant 30 at a physical location.

In a preferred embodiment, the operator 10 has a group of originating agents 20 that seek and obtain merchants 30 to offer products and/or services at a discount to buyers 40 on operator's 10 website.

FIG. 3 illustrates how originating agents 20 interface with merchants 30 in order to get offers for posting on the operator's 10 website. The originating agents 20 may contact the merchants 30 various different ways, including email, telephone, through Internet networks, or even in person.

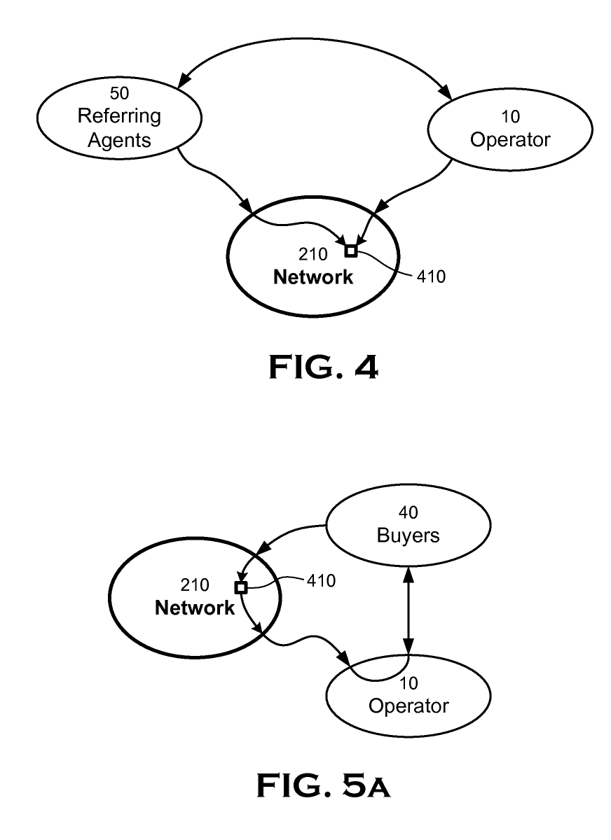

FIG. 4 illustrates how referring agents 50 can post a link 410 onto a network 210, wherein the link 410 allows visitors to the network 210 to access a merchant offer that is being hosted on the operator's 10 website. The link posted by the referring agent 50 contains identifying information that provides the referring agent 50 with credit if a buyer were to purchase a merchant's offer through this link 410.

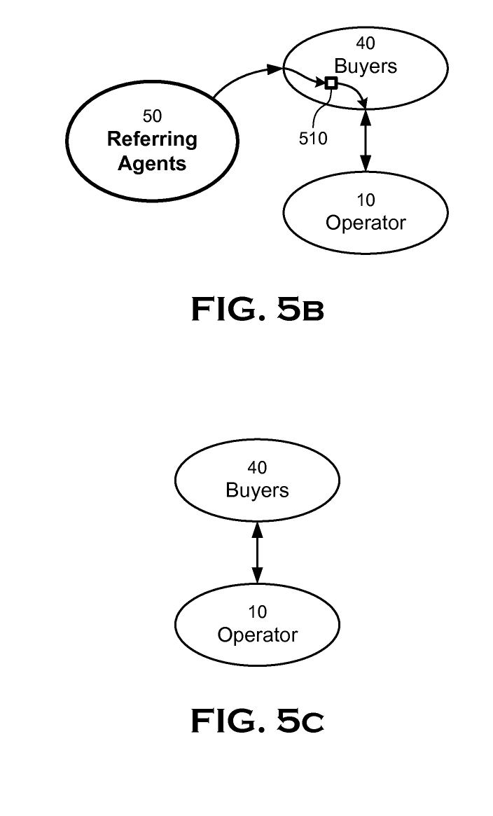

FIG. 5A illustrates how buyers 40 are connected to the operator 10 by selecting a link 410 for a merchant's offer that is posted on network 210. After selecting the link 410, the buyer is able to purchase a merchant's offer that is hosted on the operator's 10 website.

FIG. 5B further illustrates how referring agents 50 can send buyers 40 a link 510 identifying a merchant offer that is hosted on the operator's 10 website., wherein the buyer 40 can select the link 510 and get connected with the operator 10 in order to purchase the merchant offer sent by email from the referring agent 50. As previously indicated, link 510 would include identifying information that would credit the referring agent 50 for any sales made from his referral.

FIG. 5C illustrates how buyers 40 can connect directly to the operator's 10 website in order to find and purchase merchant offers. In this case since there was no referring agent, credit would not be given to a referring agent, but only to an originating agent.

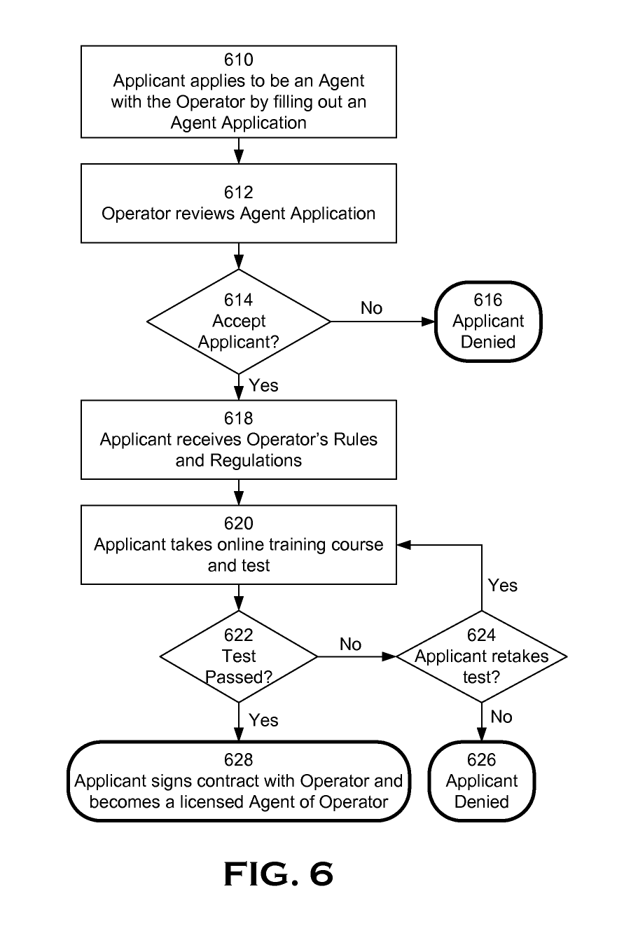

FIG. 6 depicts a flow chart showing one way how an individual can become a licensed agent of the operator. This could apply to both originating agents and referring agents, however, different rules and regulation may be required. At step 610 an individual applies to be an authorized agent of the operator by filling out an agent application. Next, at step 612 the operator reviews the agent application and determines if they will accept the applicant at step 614 based on various criteria. If the operator does not accept the applicant, then the operator will deny the applicant at step 616. If the operator accepts the applicant, then the operator passes along a set of rules and regulations to the applicant at step 618.

Next at step 620 the applicant takes an online training course and test that teaches the applicant the proper rules and procedures on how to be an authorized agent of the operator. If the applicant does not pass the test at step 622, then the applicant may be given the option to retake the test at step 624 and revert to step 620, otherwise if the applicant does not retake the test then the applicant is denied as an agent at step 626. If, however, the applicant passes the test, then at step 628 the applicant becomes a licensed agent of the operator.

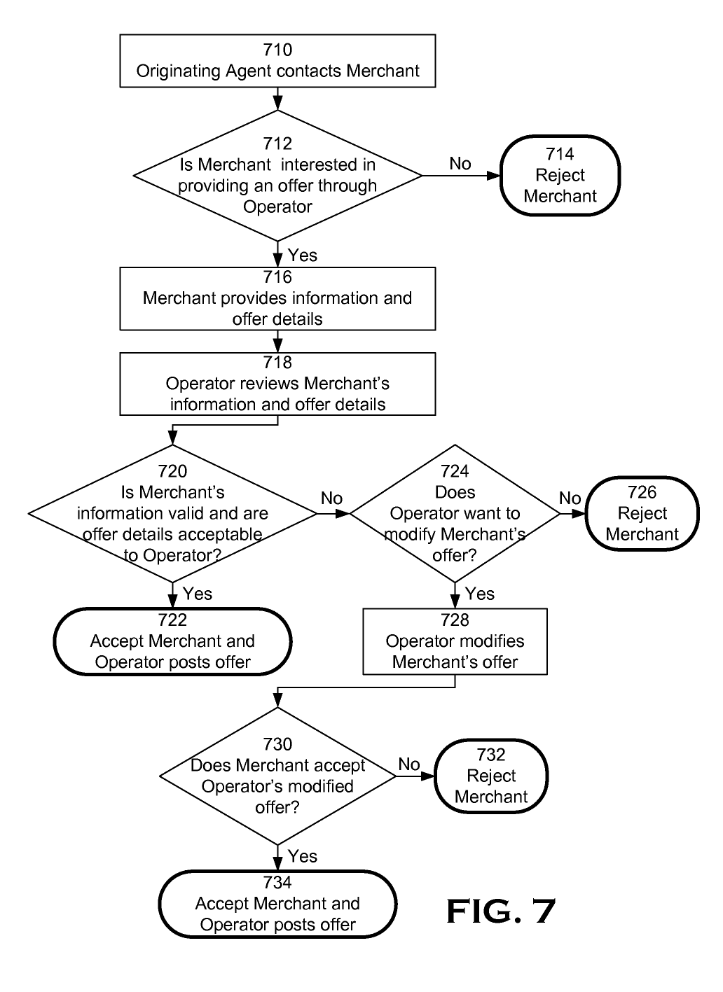

FIG. 7 is a flow chart showing one way of how an originating agent signs up a merchant for posting a merchant offer on the operator's website. First at step 710 the originating agent contacts the merchant. The originating agent may contact the merchant many different ways, such as by email, the Internet, by telephone, by regular mail, by fax, or even in person. The originating agent explains to the merchant how they can post an offer for goods and/or services on operator's website, if the merchant is not interested at step 712 then the merchant is rejected at step 714. If, however, the merchant is interested at step 712, then at step 716 the merchant is asked to provide some basic information and details of the offer that will be then passed on to the operator for review at step 718. This can be done electronically over the Internet, via email, via fax, through an iPhone, over a telephone, or by various other means.

If the operator finds the merchant's offer details acceptable at step 720, then the merchant is accepted at step 722 and the offer will then be posted on the operator's website for purchase. If the operator does not find the merchant's offer details acceptable (i.e. not a good enough deal, too expensive, products or services are not acceptable) then the operator may want to modify the merchant's offer at step 724. If the operator is not interested in modifying the merchant's offer then the merchant is rejected at step 726. If the operator decides to modify the offer, then they modify the offer at step 728 and give the merchant an opportunity to accept the modified offer at step 730. If the merchant does not accept the modified offer then the merchant is rejected by the operator at step 732. If, however, the merchant accepts the modified offer at step 734, then the operator posts the modified on its website.

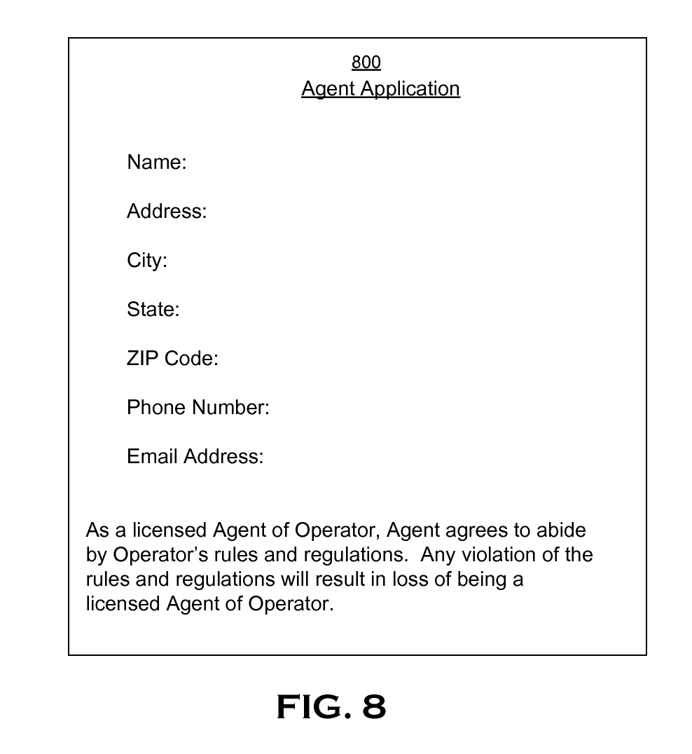

FIG. 8 illustrates a typical agent application 800, wherein the agent is asked to provide some basic information to the operator. The basic information typically includes the agent's name, address, city, state, zip code, phone number and email address. There may also be some rules and regulations set forth on the application so that the agent would act in a respectable manner so as to not cause harm to operator's business.

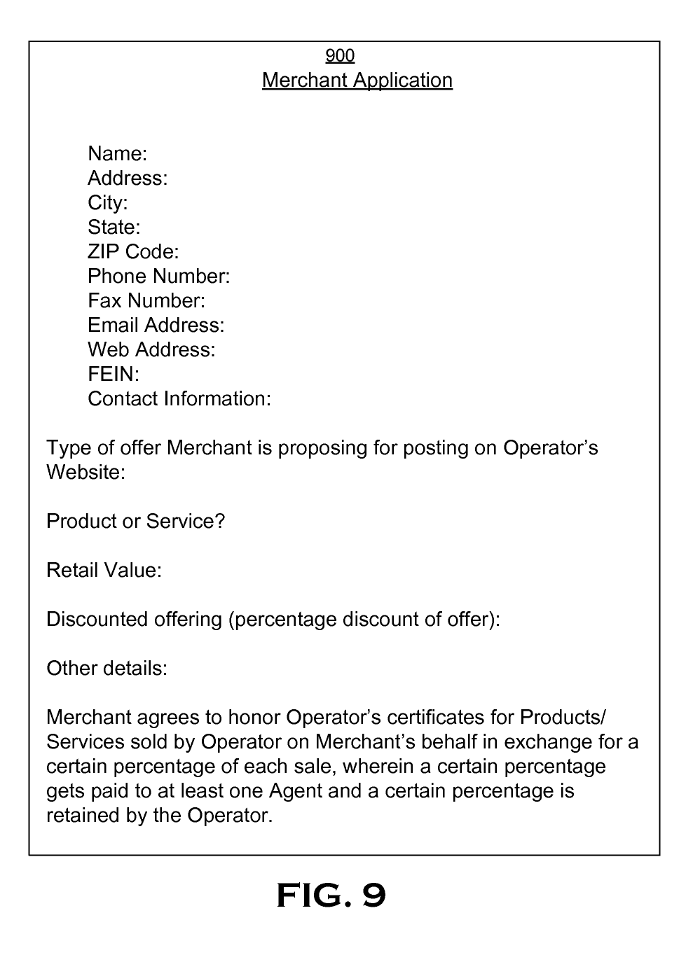

FIG. 9 illustrates a typical merchant application 900, wherein the merchant is asked to provide some basic information to the operator. The basic information typically includes the merchant's name, address, phone number, fax number, email address, web address, FEIN number and contact information. The application also includes a section identifying what kind of product and/or service the merchant is offering, at what price, and at what discount as compared to the retail value. Since a percentage of the sale will be split between the operator, the originating agent and any referring agent(s), the merchant may either suggest or negotiate what percentage of the sales will flow from the operator to the merchant, or the merchant may be required to provide a discount beyond a certain percentage in order to be considered by the operator.

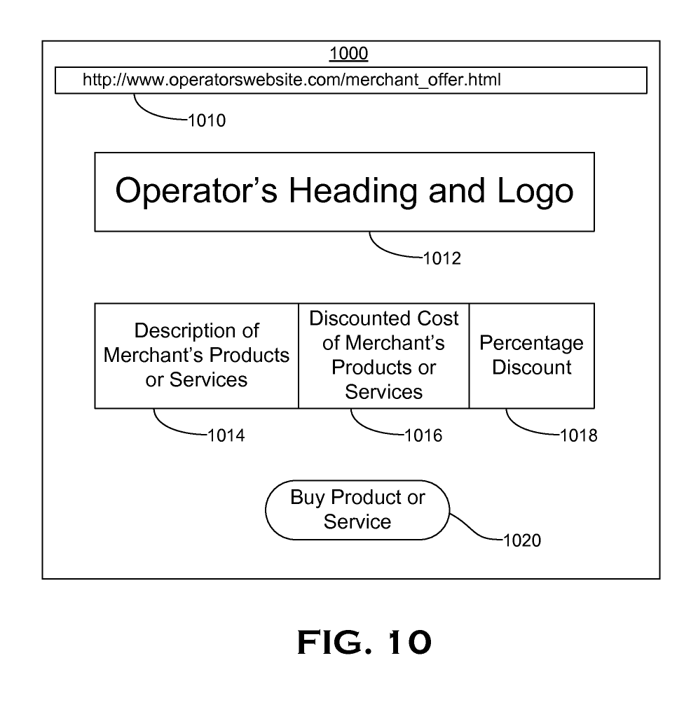

FIG. 10 illustrates a typical operator's webpage 1000 advertising a merchant's offer having a typical uniform resource locator or url at 1010 starting with “http://www.” The webpage 1000 typically has the operator's heading and logo 1012 situated on the page. The webpage also displays at least one merchant's offer showing the description of the merchant's products or services 1014, the discounted cost of the merchant's products or services 1016, and the percentage discount 1018 given by the merchant. Other various pieces of information about the merchant or about the merchant's offer may also be provided. The webpage 1000 also provides a button link 1020 that allows an individual to select and buy the featured product or service.

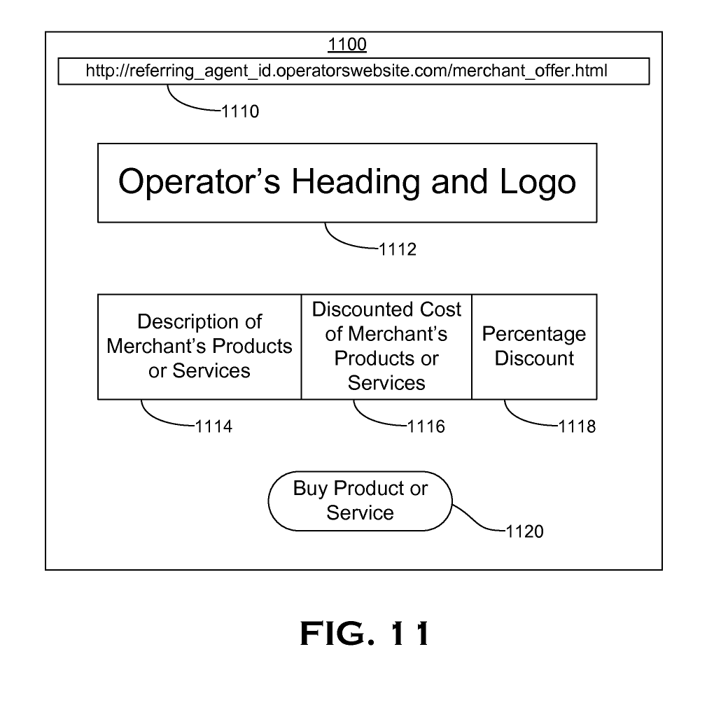

FIG. 11 illustrates a typical operator's webpage 1100 advertising a merchant's offer that is being specifically referred by a referring agent having an url at 1110 starting with “http://referring_agent_id.” Using the url as a way to identify that a referring agent helped make a sale is a great way to keep track of who the referring agent was. Various other methods known in the art of providing the referring agent with credit could also be used. The webpage 1100 can look just like the typical operator's webpage shown in FIG. 10, wherein the operator's heading and logo 1112 are situated on the page. The webpage also displays at least one merchant's offer showing the description of the merchant's products or services 1114, the discounted cost of the merchant's products or services 1116, and the percentage discount 1118 given by the merchant. Other various pieces of information about the merchant or about the merchant's offer may also be provided. The webpage 1100 also provides a button link 1120 that allows an individual to select and buy the featured product or service.

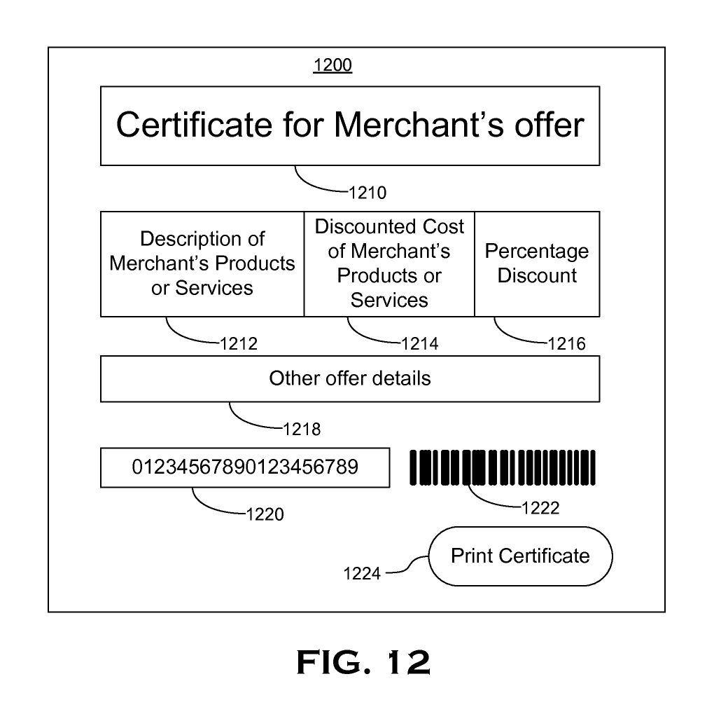

FIG. 12 shows a typical certificate on an operator's webpage 1200 after a buyer purchases an offer on the operator's website. The certificate is titled at 1210, provides a description 1212 of the products or services purchased by the buyer, shows what the discounted cost 1214 that the buyer paid, show how big of a percentage discount 1216 the buyer received, and any other offer details 1218. The certificate may also have a unique identifying number 1220 and a scanable code 1222, such as a typical barcode. The unique identifying number and/or the barcode help the merchant and operator verify that the certificate is valid and that it can be individually tracked to make sure that it is only used once. Various other different verification and tracking methods of certificates known in the art can also be used so long as the merchant can verify with the operator that the certificate is valid and that it is only used once. A convenient “print certificate” button 1224 is provided at the bottom of the screen. Alternatively, the operator can issue an electronic certificate that the buyer can redeem with the merchant online. This can be done many different ways, such as with a code, or even with the buyer's own name and address.

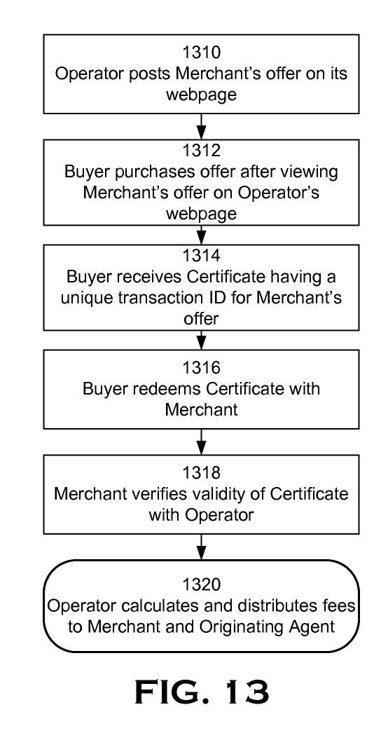

FIG. 13 is a flow chart showing a typical transaction where there was an originating agent, but no referring agent. At step 1310 the operator posts a merchant's offer on its webpage. Next at step 1312, a buyer purchases a merchant's offer from the operator's website. The buyer then receives a certificate having a unique transaction identification number for the merchant's offer at step 1314. At step 1316 the buyer then redeems the certificate with the merchant, while the merchant then verifies the validity of the certificate with the operator at step 1318. The operator then calculates and pays the merchant and the originating agent their respective fees at step 1320.

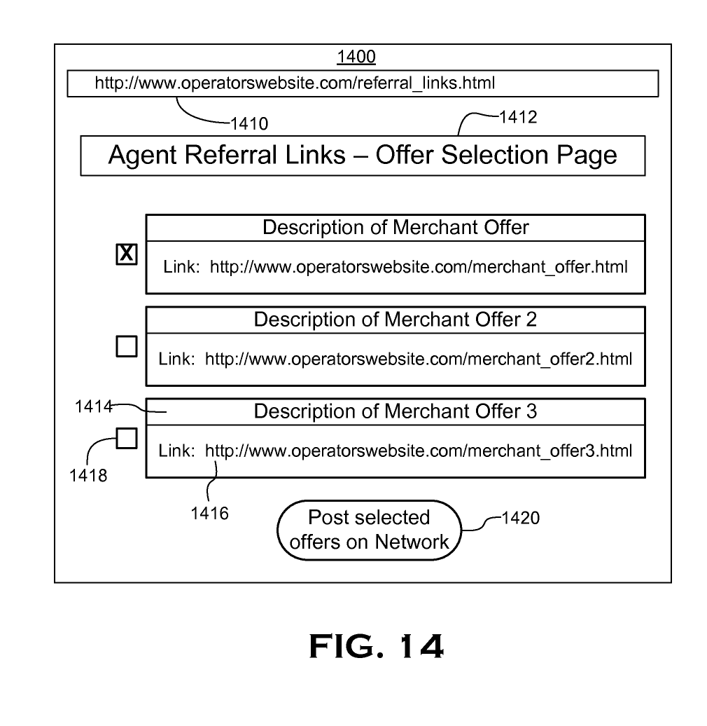

FIG. 14 depicts an operator's webpage 1400 with list of links an originating agent may want to post to his network. Since the originating agent is referring merchant offers that he himself obtained, a general link to the offers without an identifying agent id is all that is needed, as the originating agent is able to receive a commission on sales made without a referring agent. The webpage url 1410 is a standard link that begins with “www.” The webpage is titled at 1412 as an “Agent Referral Links—Offer Selection Page.” The selectable links show descriptions of various merchant offers 1414, a link to the operator's webpage for that particular offer 1416, and a selection box 1418. The originating agent only needs to select the selection boxes of the links he would like to post to his network. After making the selections, the originating agent presses the post button 1420 and the links can automatically post to the originating agents pre-programmed networks. Excellent results can be obtained by using the widely known “Facebook” network, located at http://www.facebook.com/. As is typical with Facebook, posting links to other webpages that have photos, videos, stories, and offers to “friends” within your network is a commonly known practice.

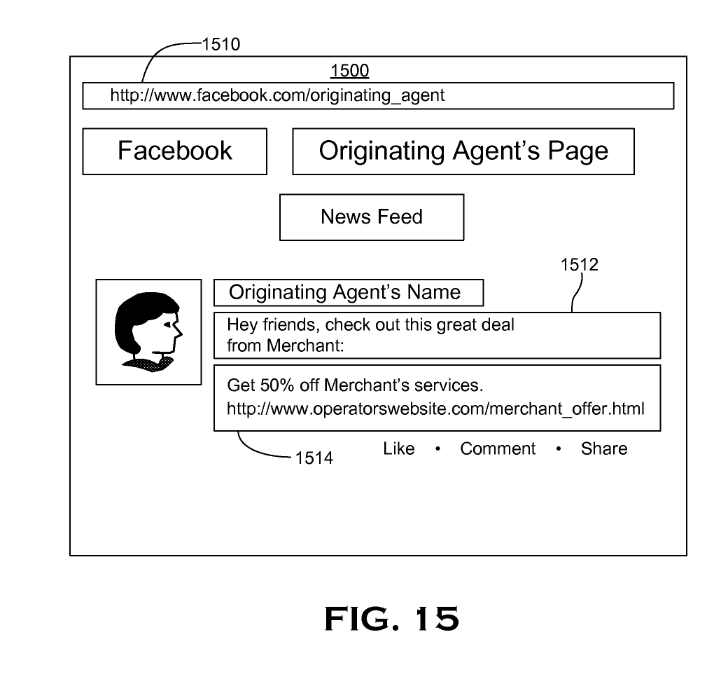

FIG. 15 shows a typical originating agent's Facebook network page 1500. The webpage url is indicated at 1510 and is identified as the originating agent's Facebook page. In this instance the originating agent posts a “news feed” that is readable to people that the originating agent is connected to. The originating agent's comment about the offer is posted at 1512 and a link to the merchant's offer on the operator's website is posted at 1514. Such a posting and referral by the originating agent immediately notifies all other selected individuals that are connected to the originating agent's network of friends of the offer. Since the referral is being made to individuals typically known by the originating agent, there would more likely be a greater consideration and review of the merchant offer by the originating agent's network of friends and greatly increase the chances of a sale.

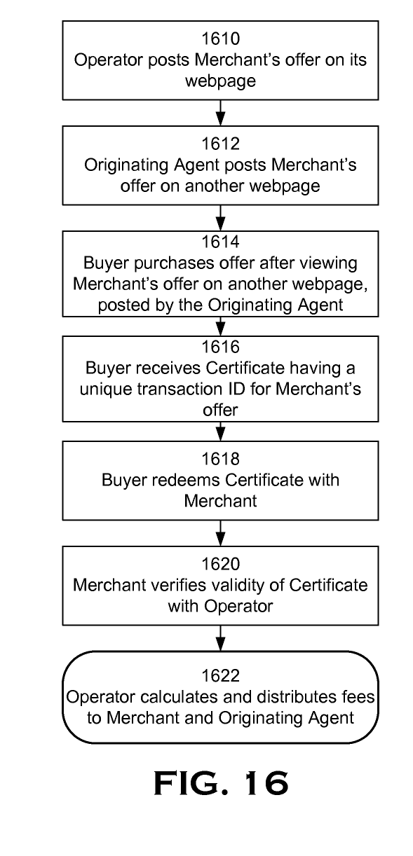

FIG. 16 further illustrates a flow chart depicting how an originating agent posts a merchant offer on a webpage other than the operator's. At step 1610 the operator initially posts the offer on its website. At step 1612 the originating agent posts the offer on another webpage, such as Facebook, LinkedIn, MySpace, or any other viewable webpage on the Internet. After viewing the offer at a website other than the operator's, a buyer then purchases the offer at step 1614. The buyer then receives a certificate for the offer at step 1616. The buyer can then redeem the certificate with the merchant at step 1618. The merchant verifies the validity of the certificate at step 1620. The operator then calculates and pays the merchant and the originating agent their respective fees that have been agreed upon in advance at step 1622.

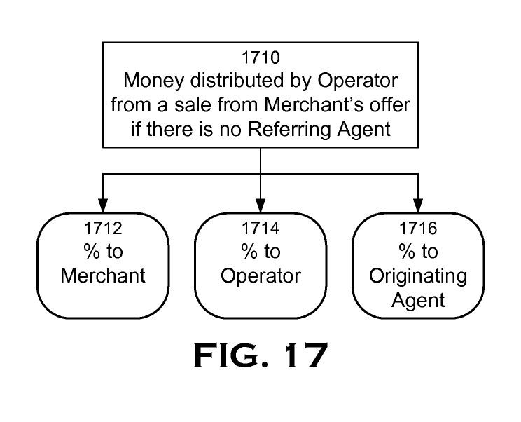

FIG. 17 illustrates one example of how money from the sale of a merchant's offer is distributed by the operator. At step 1710, if there is only an originating agent and no referring agent involved in the sale, then an agreed upon percentage goes to the merchant at step 1712, an agreed upon percentage stays with the operator at step 1714, and an agreed upon percentage goes to the originating agent at step 1716. The respective percentages that get distributed can be automatically calculated by the operator or on the operator's servers. The distribution of money can also be performed automatically via the operator's servers by automatically crediting known accounts of the originating agent and the merchant.

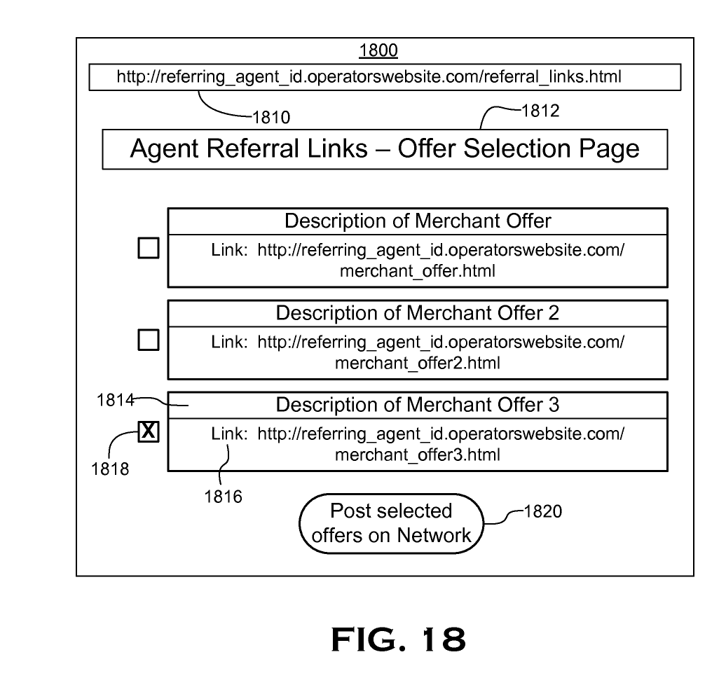

FIG. 18 depicts an operator's webpage 1800 with list of links a referring agent may want to post to his network. As the referring agent is referring merchant offers that he did not obtain, a unique link to the offers having an identifying agent id is used to help identify that the referral came from the referring agent, and so that the referring agent is able to receive a commission on sales made from his referrals. The webpage url 1810 is a unique link that begins with “referring_agent_id.” The webpage is titled at 1812 as an “Agent Referral Links—Offer Selection Page.” The selectable links show descriptions of various merchant offers 1814, a link to the operator's webpage for that particular offer 1816, and a selection box 1818. The referring agent only needs to select the selection boxes of the links he would like to post to his network. After making the selections, the referring agent presses the post button 1820 and the links can automatically post to the referring agents pre-programmed networks. Excellent results can be obtained by using the widely known “Facebook” network, located at http://www.facebook.com/, as was similarly described with reference to FIG. 14.

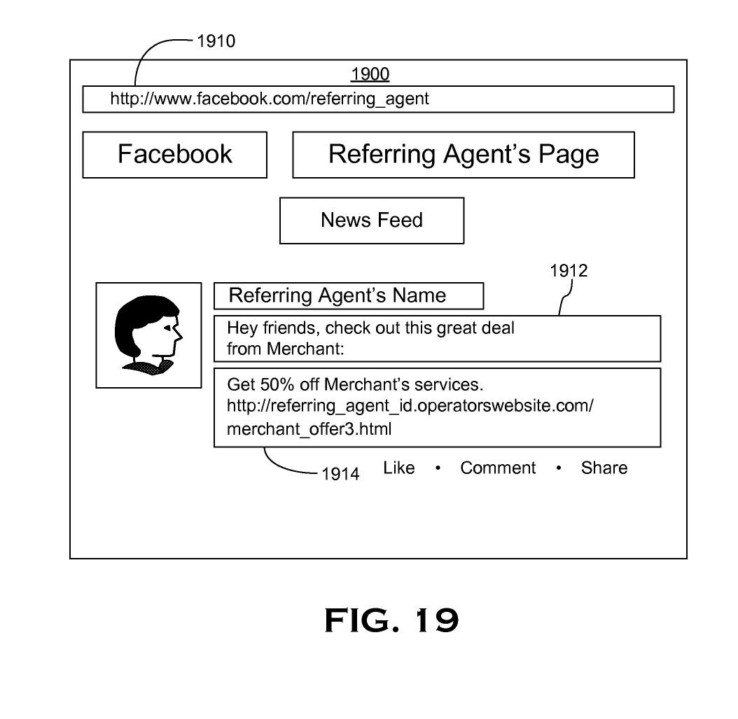

FIG. 19 shows a typical referring agent's Facebook network page 1900. The webpage url is indicated at 1910 and is identified as the referring agent's Facebook page. In this instance the referring agent posts a “news feed” that is readable to people that the referring agent is connected to. The referring agent's comment about the offer is posted at 1912 and a unique link to the merchant's offer on the operator's website is posted at 1914, wherein the unique link contains identifying information so as to give the referring agent credit for any sales that result from using this link Such a posting and referral by the referring agent immediately notifies all other selected individuals that are connected to the originating agent's network of friends of the offer. Since the referral is being made to individuals typically known by the referring agent, there would more likely be a greater consideration and review of the merchant offer by the referring agent's network of friends and greatly increase the chances of a sale.

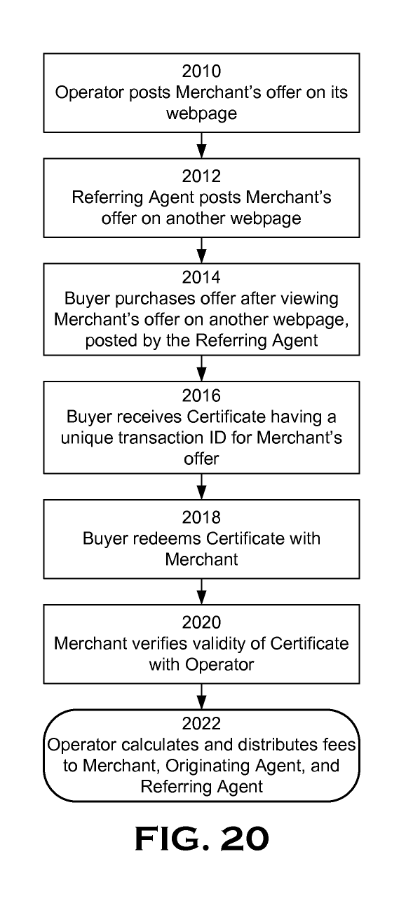

FIG. 20 further illustrates a flow chart depicting how a referring agent posts a merchant offer on a webpage other than the operator's. At step 2010 the operator initially posts the offer on its website. At step 2012 the referring agent posts the offer on another webpage, such as Facebook, LinkedIn, MySpace, or any other viewable webpage on the Internet. After viewing the offer at a website other than the operator's, a buyer then purchases the offer at step 2014. The buyer then receives a certificate for the offer at step 2016. The buyer can then redeem the certificate with the merchant at step 2018. The merchant verifies the validity of the certificate at step 2020. The operator then calculates and pays the merchant, the originating agent, and the referring agent their respective fees that have been agreed upon in advance at step 2022.

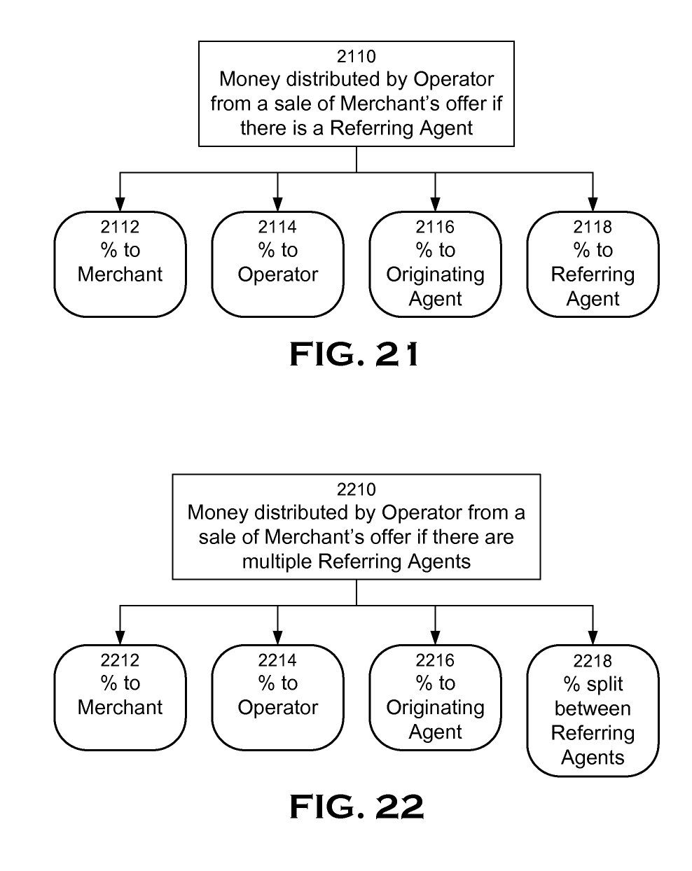

FIG. 21 illustrates another example of how money from the sale of a merchant's offer is distributed by the operator. At step 2110, if there is an originating agent and a referring agent involved in the sale, then an agreed upon percentage goes to the merchant at step 2112, an agreed upon percentage stays with the operator at step 2114, an agreed upon percentage goes to the originating agent at step 2116, and an agreed upon percentage goes to the referring agent at step 2118. The respective percentages that get distributed can be automatically calculated by the operator or on the operator's servers. The distribution of money can also be performed automatically via the operator's servers by automatically crediting known accounts of the originating agent, the referring agent, and the merchant.

FIG. 22 illustrates yet another example of how money from the sale of a merchant's offer is distributed by the operator. At step 2210, if there is an originating agent and multiple referring agents, then an agreed upon percentage goes to the merchant at step 2112, an agreed upon percentage stays with the operator at step 2114, an agreed upon percentage goes to the originating agent at step 2116, and an agreed upon percentage is split between the referring agents at step 2118. The respective percentages that get distributed can be automatically calculated by the operator or on the operator's servers. The distribution of money can also be performed automatically via the operator's servers by automatically crediting known accounts of the originating agent, the referring agents, and the merchant.

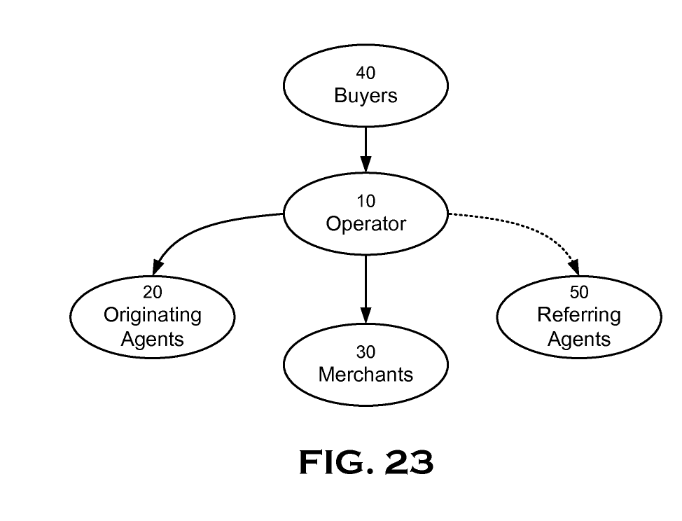

FIG. 23 further illustrates how money from the buyer passes throughout a transaction in accordance with the present invention. When a buyer 40 purchases a merchant offer for goods and/or services at operator's 10 website, money passes from the buyer 40 to the operator 10. The operator 10 will then distribute the money from the buyer accordingly, wherein: a certain percentage will pass to the originating agent 20 that found the merchant 30; a certain percentage will pass to the merchant 30; and a certain percentage will pass to a referring agent 50. If there was no referring agent 50, then the operator 10 may agree in advance to distribute the money to the originating agent 20, and/or to the merchant 30.

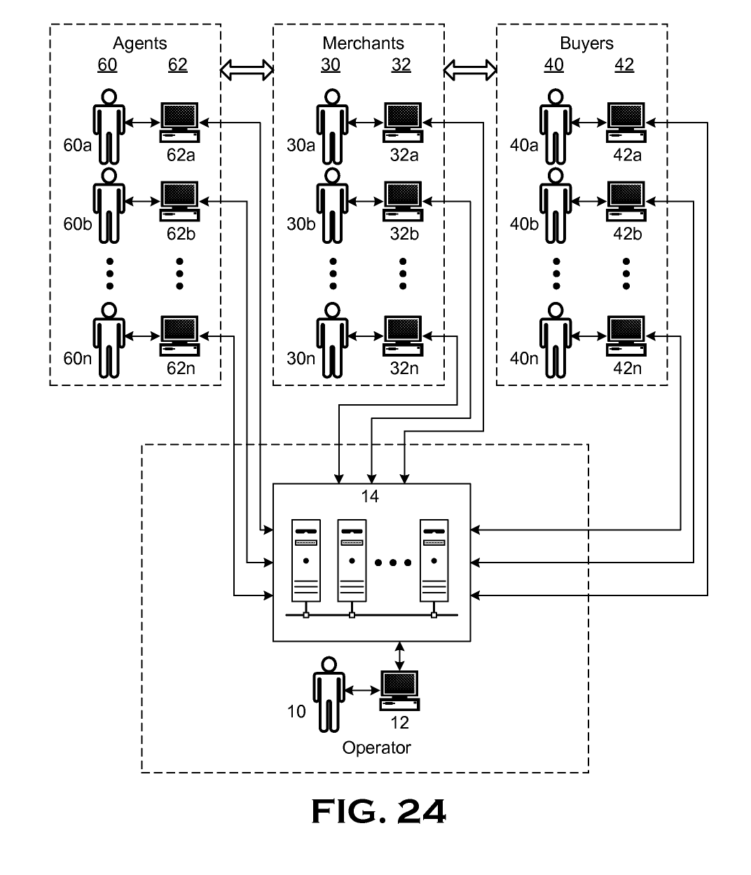

FIG. 24 illustrates an overall block diagram of another embodiment of the present invention, wherein there are agents that perform both the duties of originating agents and referring agents, as outlined above.

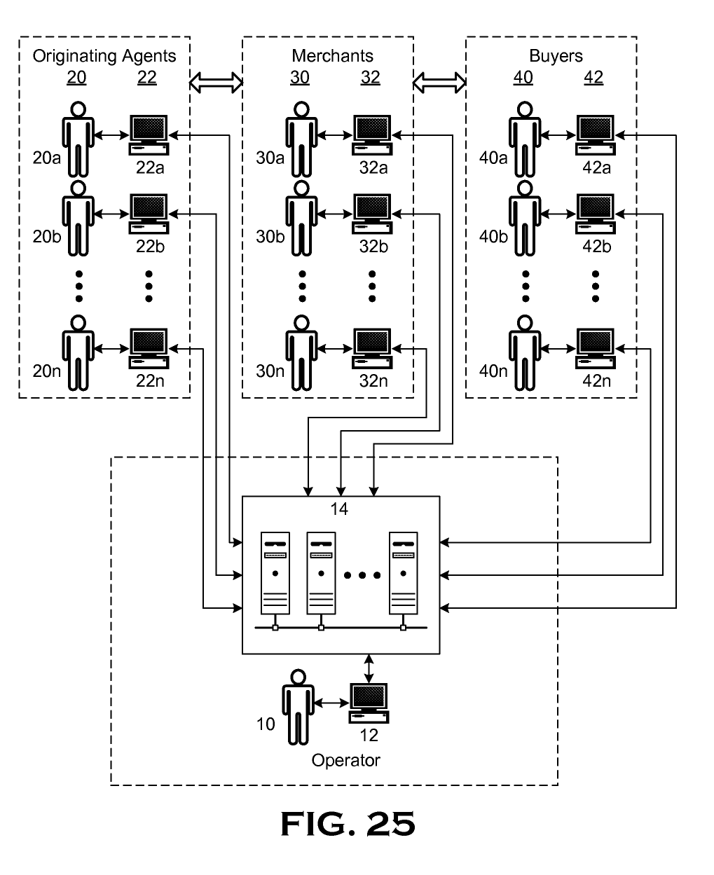

FIG. 25 illustrates an overall block diagram of yet another embodiment of the present invention, wherein there are only originating agents that perform the duties of originating agents, as outlined above.

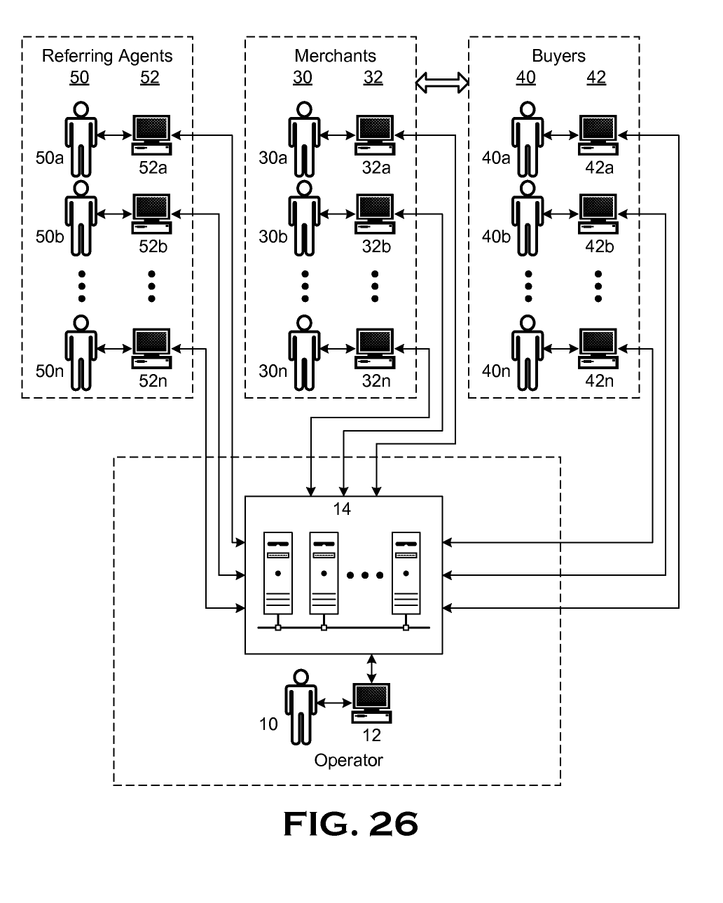

FIG. 26 illustrates an overall block diagram of still another embodiment of the present invention, wherein there are only referring agents that perform the duties of referring agents, as outlined above.

The preferred embodiment of this invention described above provides incentives to originating agents and referring agents to help market merchant offers over the Internet. Originating agents are given commissions or percentages from each sale that the operator handles with regards to any and all merchants that they signed up to provide offers that are hosted on the operator's website. Referring agents are also given commissions or percentages from each sale with regards to any purchases made based on their respective referrals. The referrals made by the referring agents often times can carry more credibility and help attract more customers to purchase products and services on the operator's website. While multiple referring agents could be used, it is a preferred embodiment of this invention to only allow one referring agent to earn a commission for a referred sale, as multi-level marketing schemes are typically unattractive, and do not provide for a large enough commission.

Originating agents have a different responsibility as referring agents, wherein originating agents need to help convince a merchant to provide an attractive enough offer for posting on the operator's website. It is contemplated that originating agents can also act as referring agents, but that some referring agents do not need to act as originating agents. If this is the case, the operator may choose to have a different set of rules and regulations for the originating agents and the referring agents.

This invention works well with, and in addition to, all various types of operator based websites that employ “group buying” techniques that typically provide a large discount of merchant products or services. Such discounts can typically range from 40% to 90% or more from their retail value. This includes operator sites that sell products and services using: demand aggregation (consolidating demand by potential buyers for products or services offered by merchants), demand-based pricing (prices that go down as the volume of units sold goes up), a buying group (a group of buyers that participate in a given offer), group buying (multiple buyers coming together in a group to buy products or services in volume), aggregate demand (the total amount of products that buyers have indicated a desire to buy), aggregate demand threshold (the aggregate demand required for a product to be sold at a particular price), maximum aggregate demand threshold (the demand threshold above which the price will not decrease further), a buying cycle (the period during which buyers can indicate a desire to purchase a product, wherein at the end of the buying cycle, the demand is counted to determine the price at which the product will sell), and maximum available amount (the maximum amount of a product that a merchant is will to sell during a buying cycle). Such operator websites that would work well with this invention include publicly known websites such as: Groupon, LivingSocial, Google Offers, Gilt City, BuyWithMe, Tippr, We Give to Get, DealOn, HomeRun, and KGB Deals.

It should be understood that while various preferred embodiments of the invention have been described, those skilled in the art could make various changes in form and detail without departing from the spirit and scope of the invention. Applicant's invention is limited only by the scope of the appended claims.

I claim:

1. A method for an operator to market discounted merchandise over the Internet through an operator website to a plurality of individual buyers, comprising the steps of:
finding a merchant through an originating agent to sell merchandise through the operator website;
posting merchandise from the merchant for sale on the operator website;
marketing the merchandise through a referring agent by posting at least one link describing the merchandise on a network connected to the Internet;
collecting money from individual buyers purchasing the merchandise through the at least one link posted by the referring agent on the network;
issuing certificates to the individual buyers to use in exchange for the merchant's merchandise;
distributing various percentages of the collected money to the merchant, the originating agent, and the referring agent; and
retaining a remaining percentage of the money.

2. The method of claim 1, wherein the merchandise is selected from the group consisting of products and services.

3. The method of claim 1, wherein the originating agent and the referring agent are the same person.

4. The method of claim 1, wherein said certificates are selected from the group consisting of electronic certificates, and paper certificates.

5. The method of claim 1, wherein the network is selected from the group consisting of: Facebook, LinkedIn, and MySpace.

6. A method for an operator to market discounted merchandise over the Internet through an operator website to a plurality of individual buyers, comprising the steps of:
finding a merchant to sell merchandise through the operator website;
posting merchandise from the merchant for sale on the operator website;
marketing the merchandise through the agent by posting at least one link describing the merchandise on a network connected to the Internet;
collecting money from individual buyers purchasing the merchandise through the at least one link posted by the agent on the network;
issuing certificates to the individual buyers to use in exchange for the merchant's merchandise;
distributing various percentages of the collected money to the merchant, and the agent; and
retaining a remaining percentage of the money.

7. The method of claim 6 wherein the merchandise is selected from the group consisting of products and services.

8. The method of claim 6 wherein said certificates are selected from the group consisting of electronic certificates, and paper certificates.

9. The method of claim 6, wherein the network is selected from the group consisting of: Facebook, Linkedln, and MySpace.

10. A system for incentivizing the marketing and sale of discounted merchandise from merchants over the Internet to a plurality of individual buyers comprising:
an operator;
web pages that display merchant offers from said merchants through the operator;
referring agent terminals that communicate with said plurality of individual buyers by linking them to merchant offers hosted on said web pages of the operator;
a plurality of buyer terminals that communicate with said operator whereby said plurality of individual buyers can purchase at least one of said merchant offers; and
said operator calculating and distributing certain percentages from the sales of merchandise to the merchant, the referring agent, and the operator.

11. The system of claim 10 further comprising a plurality of originating agent terminals that communicate with said operator, whereby said originating agent terminals can transmit to said operator merchant offers for selling merchandise from said merchants, and whereby said operator further distributes a certain percentage from the sales of merchandise to the originating agent.

12. The system of claim 10, wherein said plurality of buyer terminals are terminals connected to the Internet.

13. The system of claim 10, wherein said referring agent terminals are terminals connected to the Internet.

14. The system of claim 11, wherein said originating agent terminals are terminals connected to the Internet.

15. The system of claim 10, wherein said operator comprises a server.
